(19) United States
(12) Patent Application Publication
(10) Pub. No.: US 2020/0036313 A1
(43) Pub. Date: Jan. 30, 2020

(54) APPARATUS FOR CONTROLLING COMPRESSOR, CONTROL SYSTEM FOR COMPRESSOR, AND METHOD FOR CONTROLLING COMPRESSOR

(71) Applicant: LG ELECTRONICS INC., Seoul (KR)

(72) Inventors: Sanghoon NAM, Seoul (KR); Taekyoung KIM, Seoul (KR); Namsik YIM, Seoul (KR)

(21) Appl. No.: 16/523,430

(22) Filed: Jul. 26, 2019

(30) Foreign Application Priority Data
Jul. 27, 2018 (KR) 10-2018-0088126

(51) Int. Cl. H02P 21/34; H02P 21/18; H02P 21/22; H02P 27/12; F04D 27/00; F04D 25/06

(52) U.S. Cl. CPC H02P 21/34; H02P 21/18; H02P 21/22; H02P 2203/03; F04D 27/004; F04D 25/06; H02P 27/12

(57) ABSTRACT

The present disclosure relates to an apparatus for controlling a compressor, a control system for a compressor, and a method for controlling a compressor, whereby a rotor is aligned by exciting each phase of a stator according to a preset reference order to thereby control operation of the motor, when operation of a motor of a compressor starts.

### CROSS-REFERENCE TO RELATED APPLICATION

Pursuant to 35 U.S.C. § 119(a), this application claims the benefit of an earlier filing date of and the right of priority to Korean Application No. 10-2018-0088126, filed on Jul. 27, 2018, the contents of which are incorporated by reference herein in its entirety.

### BACKGROUND OF THE DISCLOSURE

### 1. Field of the Disclosure

The present disclosure relates to control of initial operation of a motor of a compressor, and more particularly, to an apparatus for controlling a compressor, a control system for a compressor, and a method for controlling a compressor, whereby a position of a rotor is aligned to detect a position of the motor.

### 2. Description of the Related Art

The related art of the present disclosure relates to a control apparatus (an inverter) for controlling a motor-operated compressor.

Motor-operated compressors use a permanent magnet synchronous motor (motor). According to an operation principle of the permanent magnet synchronous motor, an accurate position of a rotor needs to be determined to control current. An encoder, a resolver, a hall sensor, etc. have been used to obtain position information. However, since such position detection elements are generally expensive and include complicated wirings and structures, a use environment of the position detection elements is limited. Accordingly, in recent years, research has been briskly conducted into sensorless control that does not use the position detection elements. However, the sensorless control has a problem in detecting an initial position. When the initial position of the motor (rotor) is not accurate, a starting torque may be reduced and a rotational direction of the motor may be reversed. Thus, a risk may be caused.

With respect to a method of detecting an initial position of a motor in the related art, direct current (DC) is applied to an a-phase of the motor (with reference to an electrical angle of 0° for an N-pole of the rotor) to thereby align the initial position of the motor with the a-phase, and then, a position of the motor is detected. However, in such a case that DC is applied to the motor, when the rotor of the motor is in a dead zone (when a position of a magnet is within or near a range from 180° to 240°), there may be cases when the initial position of the motor is not aligned with the a-phase. In this situation, when an operation speed of the motor is linearly increased, a missing step may occur, and thus, staring of the motor may fail.

That is, according to an operation principle of the permanent magnet synchronous motor (a motor) used in the motor-oriented compressor, an accurate position of the rotor needs to be determined to control operation of the motor. In the method of the related art, forced excitation is performed on an a-phase to find an initial position of a motor, and then, an operation speed is linearly increased using an open loop control (volts-per-hertz (V/F) control) method, and the motor is operated by switching from the open loop control method to a sensorless control method at a predetermined or higher speed. However, in this method of the related art, when the operation speed linearly increases after forced excitation is performed on the a-phase, a magnet of a motor may not keep up with the operation speed in some areas. Accordingly, an accurate position may not be detected, and resultantly, control of operation of the motor may not be performed. Thus, there may be such a problem that initial starting of the motor may fail.

### SUMMARY OF THE DISCLOSURE

Therefore, an aspect of the present disclosure is to overcome limitations of the related art described above.

That is, the present specification is directed to provide an apparatus for controlling a compressor, a control system for a compressor, and a method for controlling the compressor, whereby the limitations of the related art may be overcome.

In detail, one aspect of the present disclosure is to provide an apparatus for controlling a compressor, a control system for a compressor, and a method for controlling the compressor, whereby a rotor of a motor may be aligned even when the rotor is located in a position in which alignment is difficult.

Also, another aspect of the present disclosure is to provide an apparatus for controlling a compressor, a control system for a compressor, and a method for controlling a compressor, whereby a rotor may be accurately aligned before operation of the motor starts.

In addition, another aspect of the present disclosure is to provide an apparatus for controlling a compressor, a control system for a compressor, and a method for controlling a compressor, whereby a position of a motor may be accurately detected by accurately aligning a rotor.

Further, another aspect of the present disclosure is to provide an apparatus for controlling a compressor, a control system for a compressor, and a method for controlling a compressor, whereby a position of a motor may be accurately detected to thereby accurately and stably control initial operation of the motor.

To achieve these and other advantages and in accordance with the purpose of this specification, as embodied and broadly described herein, there are provided an apparatus for controlling a compressor, a control system for a compressor, and a method for controlling a compressor according to the present disclosure to align a rotor of a motor by rotating the rotor for a plurality of times when operation of the motor starts.

In detail, each phase of the stator is excited according to a reference order, and thus, the rotor is moved according to the preset reference order to thereby align the rotor with a predetermined position.

That is, the apparatus for controlling a compressor, the control system for the compressor, and the method for controlling the compressor according to the present disclosure are configured such that, when operation of the motor starts, each phase of the stator is excited according to a preset reference order and the rotor is moved for a plurality of times according to the preset reference order to thereby align the rotor from an initial position to a predetermined position.

An aspect of the present disclosure is to provide the apparatus for controlling a compressor, the control system for a compressor, and the method for controlling a compressor, whereby a rotor is moved in accordance with a reference order to be thereby aligned with a predetermined position. Thus, the rotor is aligned with the predetermined position irrespective of an initial position of the rotor so that the above-mentioned problems may be solved.

The technical features herein may be implemented as an apparatus for controlling a compressor, a control system for a compressor, and a method for controlling a compressor according to the present disclosure, whereby driving of a compressor is controlled via an inverter unit that applies driving power to a motor of the compressor. The present specification provides an apparatus for controlling a compressor, a control system for a compressor, and a method for controlling a compressor having the above-described technical features.

According to an embodiment of the present disclosure, there is provided an apparatus for controlling a compressor, the apparatus including an inverter unit and a controller, wherein the inverter unit converts power, input from an external power source to an input unit, to driving power for driving the motor and output the driving power to the motor and the controller controls operation of the motor by controlling switching operation of the inverter unit 20. Before the operation of the motor starts, the controller aligns a rotor of the motor by applying excitation power to the stator of the motor according to a preset application criterion.

According to an embodiment of the present disclosure, there is provided a control system for a compressor, the control system including a compressor and a control apparatus, wherein the compressor is driven by a motor and the control apparatus includes an inverter unit configured to convert power, input from an external power source, to driving power that drives a motor of a compressor and output the driving power to the motor, and controls operation of the motor by controlling switching operation of the inverter unit. When the motor starts to operate, the control apparatus controls the starting of the operation of the motor after aligning a rotor of the motor according to a preset alignment criterion.

According to an embodiment of the present disclosure, there is provided a method for controlling a compressor, the method being performed by an apparatus for controlling a compressor, wherein the apparatus includes an inverter unit that converts power, input from an external power source to an input unit, to driving power that drives a motor of a compressor and outputs the driving power to the motor, and a controller that controls operation of the motor by controlling switching operation of the inverter unit, the method including: aligning a rotor of the motor by applying excitation power to a stator of the motor according to a preset application criterion; rotating the motor according to a preset rotation criterion; and controlling initial operation of the motor according to a preset control criterion.

Embodiments of the apparatus for controlling a compressor, the control system for a compressor, and the method for controlling a compressor having the technical features described above may be implemented as a control apparatus, a control system and a control method whereby the initial operation of the motor is controlled.

Further, embodiments of the apparatus for controlling a compressor, the control system for a compressor, and the method for controlling a compressor having the technical features described above may be implemented as a control apparatus, a control system, and a control method, whereby the positions of the motors is aligned.

In addition, embodiments of the apparatus for controlling a compressor, the control system for a compressor, and the method for controlling a compressor having the technical features described above may be implemented as a control apparatus, a control system, and a control method, whereby a position of a motor is detected.

The apparatus for controlling a compressor, the control system for a compressor, and the method for controlling a compressor according to the present disclosure described above may be applied to an apparatus for controlling a compressor provided in a compressor, for example, an inverter apparatus for controlling a motor of the compressor, a compressor including the inverter apparatus, or a method for controlling the compressor. However, the technology disclosed in this specification is not limited thereto, and may be applied to a control apparatus for all types of compressors, a compressor, a control system for a compressor, and a method for controlling a compressor to which the technical idea of the present disclosure may be applied.

### Effects of the Disclosure

An apparatus for controlling a compressor, a control system for a compressor, and a method for controlling a compressor according to the present disclosure may have an effect of moving a rotor according to a preset reference order and aligning the rotor with a predetermined position to thereby accurately align the rotor with the predetermined position irrespective of an initial position of the rotor.

Also, the apparatus for controlling a compressor, the control system for a compressor, and the method for controlling a compressor according to the present disclosure may have an effect of accurately aligning the rotor to a predetermined position to thereby accurately detect a position of the rotor.

In addition, the apparatus for controlling a compressor, the control system for a compressor, and the method for controlling a compressor according to the present disclosure may have an effect of stably and accurately controlling operation of the motor by accurately detecting a position of the rotor.

### BRIEF DESCRIPTION OF THE DRAWINGS

FIG. 1 is a diagram illustrating a configuration of an apparatus for controlling a compressor according to the present disclosure.

FIG. 2 is a diagram illustrating an example of position alignment of a motor according to an embodiment of the present disclosure.

FIG. 3 is a configuration diagram illustrating a detailed circuit configuration of the apparatus for controlling a compressor according to the present disclosure.

FIG. 4 is a configuration diagram illustrating a detailed circuit configuration of a controller in the apparatus for controlling a compressor according to the present disclosure.

FIG. 5A is a diagram illustrating an example of a position of the motor according to an embodiment of the present disclosure.

FIG. 5B is a diagram illustrating another example of a position of the motor according to an embodiment of the present disclosure.

FIG. 6A is a diagram illustrating an example of position alignment of a rotor according to an embodiment of the present disclosure.

FIG. 6B is a diagram illustrating another example of position alignment of the rotor according to an embodiment of the present disclosure.

FIG. 6C is a diagram illustrating still another example of position alignment of the rotor according to an embodiment of the present disclosure.

FIG. 7A is a graph showing a speed change during control of initial operation of a general motor.

FIG. 7B is a graph showing a speed change during control of initial operation of the motor according to an embodiment of the present disclosure.

FIG. 8A is a flowchart of a process of controlling a control system for a compressor according to the present disclosure.

FIG. 8B is a graph showing a process of controlling the control system for a compressor according to the present disclosure.

FIG. 9 is a flowchart of an order of performing a method for controlling a compressor according to the present disclosure.

### DETAILED DESCRIPTION OF THE DISCLOSURE

The disclosure disclosed herein may be applied to an apparatus for controlling a compressor, a control system for a compressor, a method for controlling a compressor for controlling a compressor, and a compressor to which such a technique is applied. However, the disclosure disclosed in this specification is not limited thereto, and may also be usefully applied to all existing control apparatuses for a compressor, a control system for a compressor, a compressor and a method for controlling the same, a motor control apparatus, a motor driving apparatus, an inverter apparatus for controlling a motor, a method for controlling a motor control apparatus, a method for controlling an inverter apparatus, a control element for controlling the motor control apparatus and a method of controlling the motor control apparatus, a control apparatus for controlling an inverter apparatus and a method for controlling the inverter apparatus, etc. Particularly, the disclosure herein may be usefully applied to a compressor control apparatus for controlling a motor-operated compressor, a control system for a compressor, and a method of controlling a compressor.

It should be noted that technological terms used herein are merely used to describe a specific embodiment, but not to limit the present disclosure. Also, unless particularly defined otherwise, technological terms used herein should be construed as a meaning that is generally understood by those having ordinary skill in the art to which the disclosure pertains, and should not be construed too broadly or too narrowly. Furthermore, if technological terms used herein are wrong terms unable to correctly express the spirit of the disclosure, then they should be replaced by technological terms that are properly understood by those skilled in the art. In addition, general terms used in this disclosure should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

In describing the present disclosure, if a detailed explanation for a related known function or construction is considered to unnecessarily divert the gist of the present disclosure, such explanation has been omitted but would be understood by those skilled in the art. It should be noted that the attached drawings are provided to facilitate understanding of the embodiments disclosed in this specification, and should not be construed as limiting the technical idea disclosed in this specification by the attached drawings.

First, an apparatus for controlling a compressor (hereinafter referred to as a control apparatus) according to the present disclosure is described.

The control apparatus refers to a control apparatus for controlling driving of the compressor.

The control apparatus may be a control apparatus for controlling driving of the compressor by supplying driving power to a motor of the compressor.

The control apparatus may be an apparatus for controlling driving of the compressor by controlling operation of the motor.

The control apparatus may be an apparatus for controlling the motor using an inverter method.

That is, the control apparatus may be an inverter that controls driving of the compressor, or an apparatus including the inverter.

The control apparatus may control operation of the motor, by controlling the driving power applied to the motor through control of switching operation of the inverter.

The control apparatus may control driving of the compressor by controlling the operation of the motor, by controlling the driving power through the control of the switching operation.

The control apparatus may be an apparatus for controlling an initial operation of the motor.

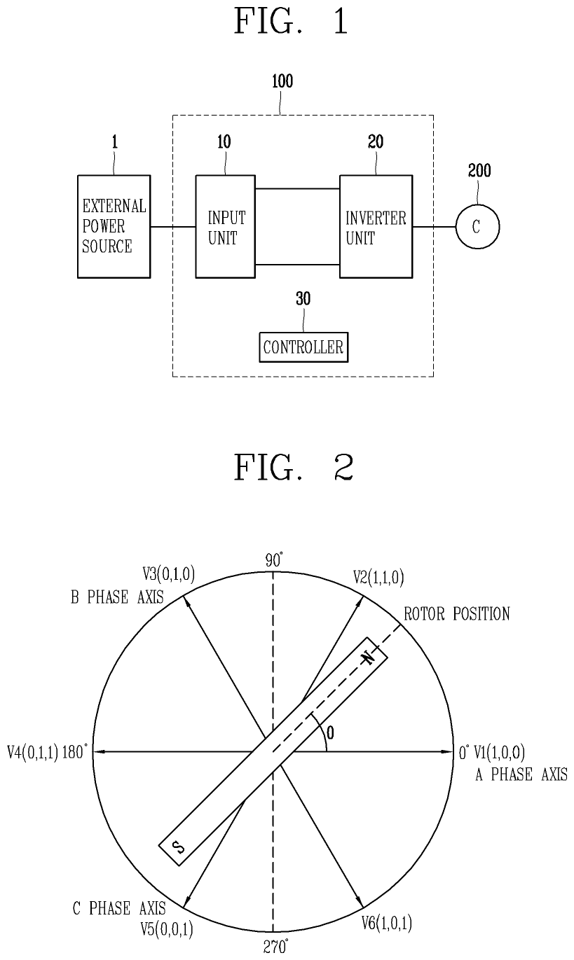

As shown in FIG. 1, the control apparatus 100 includes an inverter unit 20 and a controller 30, wherein the inverter unit 20 converts power, input from an external power source 1 to an input unit 10, to driving power for driving a motor 200 of a compressor C and outputs the driving power to the motor 200, and the controller 30 controls operation of the motor 200 by controlling switching operation of the inverter unit 20.

As the controller 30 control the driving power converted according to the switching operation by controlling the switching operation of the inverter unit 20, the control apparatus 100 controls operation of the motor 200 through the control of the driving power.

As such, in the control apparatus 100 including the input unit 10, the inverter unit 20, and the controller 30, before operation of the motor 200 starts, the controller 30 aligns a position of a rotor of the motor 200 by applying excitation power to a stator of the motor 200 according to a preset application criterion.

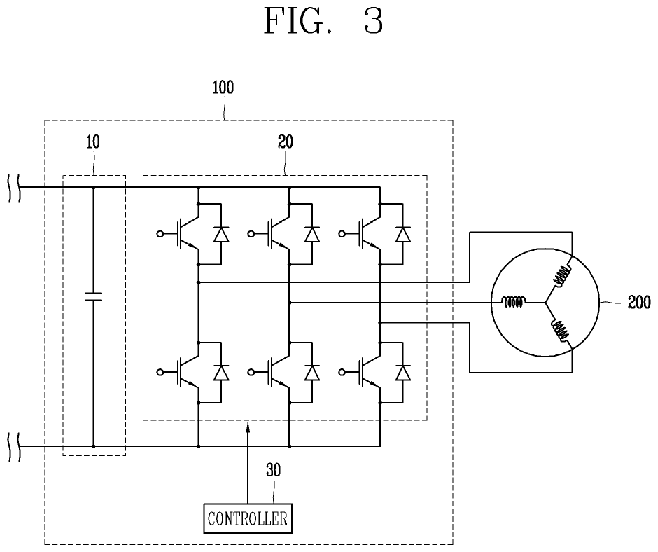

As shown in FIG. 2, before operation of the motor 200 starts, since an N-pole of the rotor is not located at a reference position (0°), a position (of the rotor) of the motor 200 may not be accurately detected. Thus, the N-pole needs to be aligned with the reference position (0°). Before an initial operation begins in this state, as the controller 30 applies the excitation power to the stator according to the preset application criterion, the N-pole is moved through forced excitation according to the excitation power. Thus, a position of the rotor is aligned.

That is, the control apparatus 100 controls the position of the rotor to be aligned with a predetermined position by moving the rotor according to the application reference.

In this way, before operation of the motor 200 is started, a position of the rotor may be aligned with the predetermined position to thereby accurately detect the position of the rotor.

As such, by accurately detecting the position of the rotor, initial operation of the motor 200 may be accurately controlled based on a result of the detection of the position, and all operations of the motor 200 may be stably performed.

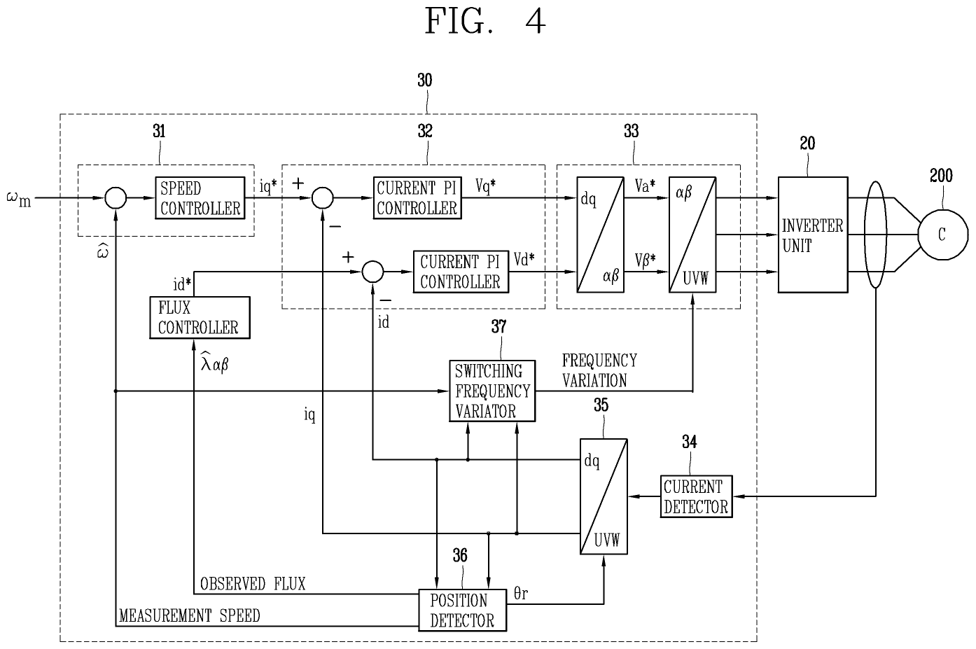

A detailed configuration of the control apparatus 100 is shown in FIG. 3.

The input unit 10 may receive an input of direct current (DC) power or alternating current (AC) power from the external power source 1.

When the power input to the input unit 10 is the DC power, the external power source 1 may be a battery for storing the DC power or a power supply element for supplying the DC power.

When the power input to the input unit 10 is the AC power, the external power source 1 may be a power conversion element for converting DC power to the AC power or a power supply element for supplying the AC power.

The input unit 10 may include a smoothing capacitor for smoothing the input power.

The smoothing capacitor may be a DC link capacitor that smooths the ripple in the form of DC power by reducing ripples of the input power to.

When the power input to the input unit 10 is the AC power, the input unit 10 may further include a rectifying unit (not shown) for rectifying the AC power input from the external power source 1 to DC power.

The input unit 10 may be connected to the inverter unit 20 and may transmit DC power smoothed by the smoothing capacitor to the inverter unit 20.

The inverter unit 20 may be connected to the motor 200, convert the DC power received via the input unit 10 to the driving power, and output the driving power to the motor 200.

Here, the motor 200 may be a three-phase motor that drives the compressor C. The driving power may be in the form of a three-phase AC power.

The inverter unit 20 may convert the DC power into the driving power in the form of the AC power through the switching operation, and output the driving power to the motor 200.

The inverter unit 20 may include a plurality of switching modules for converting the DC power into three-phase AC power.

The plurality of switching modules may be insulated gate bipolar transistor (IGBT) modules.

A switching operation of the plurality of switching modules may be controlled by the controller 30.

That is, the inverter unit 20 may be controlled by the controller 30.

The plurality of switching modules may receive a control signal for the switching operation from the controller 30, and may convert the DC power to the AC power by performing a switching operation according to the control signal.

The switching operation of the inverter unit 20 may be controlled by the controller 30 to thereby control operation of the motor 200.

The inverter unit 20 may control an operation speed of the motor 200 by controlling the driving power, output and applied to the motor 200, through the control of the switching operation.

Here, the operation speed may refer to a speed at which the motor 200 rotates.

The operation speed may also be replaced by an operation frequency at which the motor 200 is operated in relation to the operation speed or a rotation number of the motor 200.

Hereinafter, for convenience of description, an embodiment is described mainly on the operation speed. However, an embodiment of the present disclosure may be implemented in a form in which the operation speed is replaced by the operation frequency or the rotation number.

The controller 30 for controlling operation of the motor 200 by controlling the switching operation may detect a voltage and current of the motor 200, and then, measure the operation speed of the motor 200 based on the detected voltage and current of the motor 200. Thus, the controller 30 may control the switching operation according to the measured operation speed.

The controller 30 may detect a motor voltage and a motor current applied to the motor 200 according to the switching operation, and measure the operation speed based on the motor voltage and the motor current.

The controller 30 may generate a control signal for controlling the switching operation according to the operation speed, and apply the control signal to the inverter unit 20 to thereby control the switching operation.

The controller 30 may determine at least one selected from a command voltage for the motor voltage, a command current for the motor current, a speed command for the operation speed, and a frequency command for the switching frequency according to the operation speed, and generate the control signal according to a result of the determination.

That is, the controller 30 determines at least one selected from the command voltage, the command current, the speed command, and the frequency command based on at least one of a result of the detection of the motor voltage and the motor current and a result of the measurement of the operation speed. Then, the controller 30 may generate the control signal according to a result of the determination to thereby control the switching operation. Thus, the controller 30 may control at least one selected from the motor voltage, the motor current, the operation speed, and the switching frequency.

As described above, the controller 30 may control at least one selected from the motor voltage, the motor current, the operation speed, and the switching frequency through the control of the switching operation to thereby control the operation of the motor 200.

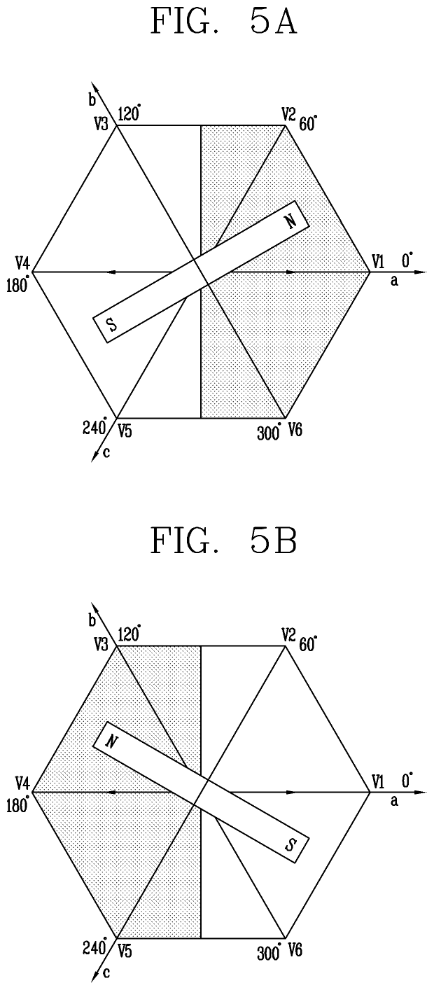

A detailed configuration of the controller 30 for controlling the switching operation is shown in FIG. 4.

As shown in FIG. 4, the controller 30 may include a speed controller 31, a current controller 32, a signal generating unit 33, a current detector 34, an axial conversion unit 35, a position detector 36 (a sensorless controller), and a switching frequency variator 37, wherein the speed controller 31 generates a command current i_{q}* according to the command speed ωₘ, the current controller 32 generates the command voltages V_{d}* and V_{q}* according to the command current i_{q}*, the signal generating unit 33 performs α-β/U-V-W conversion of the command voltages V_{d}* and V_{q}* and generates a pulse width modulation (PWM) control signal for controlling the switching operation of the inverter unit 20 according to the α-β/U-V-W conversion, the current detector 34 detects the motor current applied from the inverter unit 20 to the motor 200, the axial conversion unit 35 performs U-V-W/d-q conversion of measured current and provides feedback to the current controller 32, the position detector 36 (the sensorless controller) detects a position of the motor 200 based on a result of the axial conversion, measures the operation speed based on the detected position of the motor 200, transmits a measurement speed \hat{ }ω to the speed controller 31, transmits an observed flux \hat{ }λαβ to a flux controller, and transmits a position detection result er to the axial conversion unit 35, and the switching frequency variator 37 generates a switching frequency command for the switching operation based on the axial conversion result and the measurement speed \hat{ }ω and transmits the switching frequency command to the signal generating unit 33.

The controller 30 includes the above-described configuration, and thus may generate the control signal according to the operation speed and apply the control signal to the inverter unit 20 to thereby control the switching operation of the inverter unit 20.

Before operation of the motor 200 is started, the controller 30 for controlling the switching operation according to the operation speed may control and align a position of the rotor by applying the excitation power to the stator according to the application criterion. Thus, the controller 30 may detect a position of the rotor to thereby control the operation of the motor 200.

That is, when controller 30 controls initial operation of the motor 200 for starting operation of the motor 200, the controller 30 may align a position of the rotor, and then, control the initial operation of the motor 200.

The application criterion may be a criterion for an order of applying the excitation power to respective slots of the stator.

The application criterion may be a criterion for an order of applying the excitation power to a plurality of slots among the respective slots.

That is, the controller 30 may sequentially apply the excitation power to a plurality of slots among the respective slots according to the application criterion to thereby sequentially excite the plurality of slots.

The controller 30 may apply the excitation power according to the application criterion to thereby align the N-pole of the rotor with a predetermined position.

The predetermined position may be a position corresponding to an a-phase of the stator.

That is, the application criterion may be a criterion for an order of applying the excitation power so that the N-pole is aligned with the position corresponding to the a-phase of the stator.

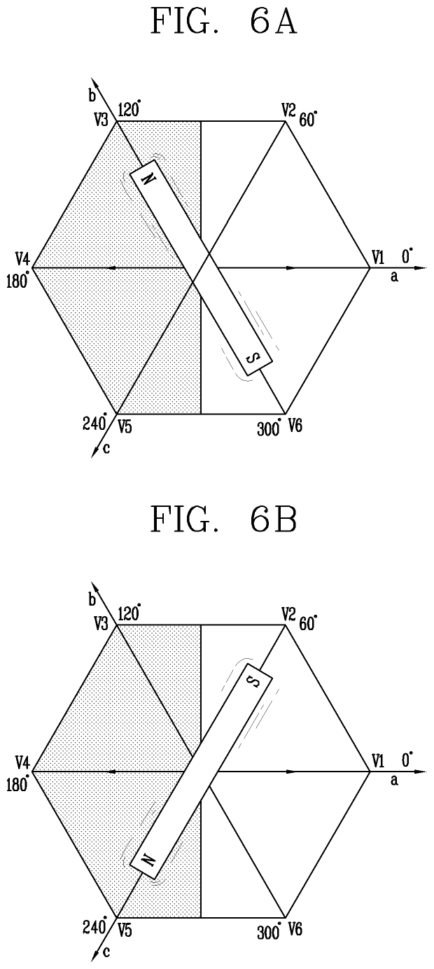

Here, as shown in FIGS. 5A and 5B, the stator may include six slots and each phase power of the three-phase power may be applied to each of the six slots.

When an example of a structure of the stator is described in detail, as shown in FIGS. 5A and 5B, a slot corresponding to the a-phase of the three-phase power among the six slots is a slot V1. The slot V1 may be a reference for a position of the rotor, and located in a position at an electrical angle of 0° according to a position of the N-pole. A slot corresponding to a b-phase is a slot V3. The slot V3 may be located in a position at an electrical angle of 120° according to a position of the N-pole. A slot corresponding to a c-phase is a slot V5. The slot V5 may be located in a position at an electrical angle of 240° according to a position of the N-pole.

That is, each phase of the three-phase power may be applied to each of slots located at an interval of 120° with reference to the slot V1. Thus, a-phase power may be applied to the slot V1, b-phase power may be applied to the slot V3, and c-phase power may be applied to the slot V5.

In addition, negative (−) power of the three-phase power may be applied to slots located in positions 180° symmetrical to positions of the slots V1, V3 and V5, respectively.

For example, a negative (−) a-phase may be applied to a slot V4 located in a position 180° symmetrical to the position of the slot V1, a negative (−) b-phase to a slot V6 located in a position 180° symmetrical to the position of the slot V3, and negative (−) c-phase to a slot V2 located in a position 180° symmetrical to the position of the slot V5.

The application criterion may be a criterion for applying the excitation power to the slots in an order of slots sequentially corresponding to the b-phase, the c-phase, and the a-phase of the stator.

That is, the controller 30 may apply the application power to the slots in an order of slots sequentially corresponding to the b-phase, the c-phase, and the a-phase to thereby excite the slots in the order of the slots sequentially corresponding to the b-phase, the c-phase, and the a-phase.

For example, the slots may be excited in an order from the slots V3, V5, to V1 by applying the b-phase power to the slot V3 corresponding to the b-phase, the c-phase power to the slot V5 corresponding to the c-phase, and the a-phase power to the slot V1 corresponding to the a-phase.

As such, by exciting the plurality of slots in an order from the slot V3 corresponding to the b-phase, the slot V5 corresponding to the c-phase, to the slot V1 corresponding to the a-phase, the N-pole of the rotor may move to and be aligned with the positions along the plurality of excited slots in an order from the position at the electrical angle of 120° corresponding to the slot V3, the position at the electrical angle of 240° corresponding to the slot V5, to the position at the electrical angle of 0° corresponding to the slot V1.

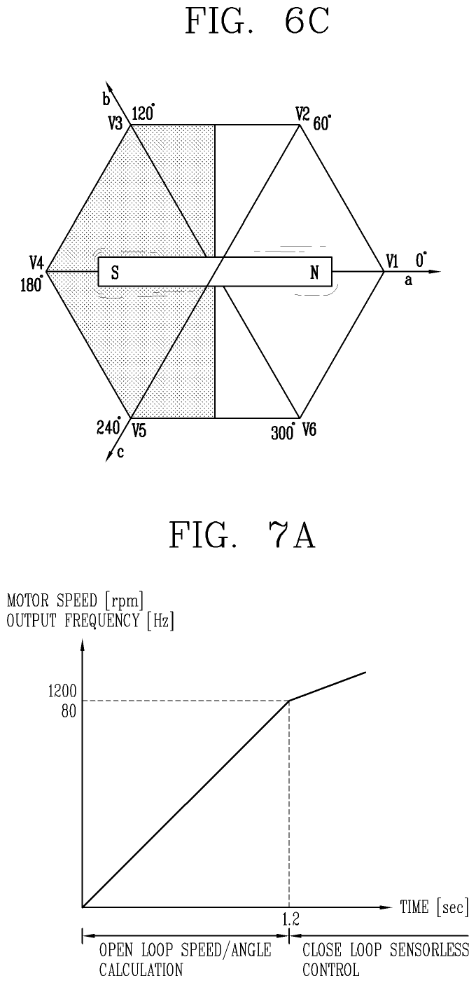

An example of such an alignment may be shown in a sequence from FIGS. 6A, 6B to 6C.

Referring to the drawings, as shown in FIG. 6A, the N-pole moves from an initial position to a vicinity of the position of the slot V3 corresponding to the b-phase at the electrical angle of 120°. Next, as shown in FIG. 6B, the N-pole moves to a vicinity of the position of the slot V5 corresponding to the c-phase at the electrical angle of 240°. Then, as shown in FIG. 6C, the N-pole moves to a vicinity of the position of the slot V1 corresponding to the a-phase at the electrical angle of 0°. Thus, the N-pole may be ultimately located at the position at the electrical angle of 0°.

By aligning the N pole in an order of positions at the electrical angles from 120°, 240°, to 0°, even when the N-pole may be located far from the initial position at the electrical angle of 0°, the N-pole may be aligned with the initial position at the electrical angle of 0°.

For example, as shown in FIG. 5B, in such a case that the N-pole is located in a shaded portion far from the position at the electrical angle of 0°—in a position between angles 90° and 270° (a dead zone)—, even when the slot V1 is excited, since the N-pole is far from the slot V1, the N-pole may not be aligned with the position at the angle of 0°. As described above, when the slots are excited in an order of the slots sequentially corresponding to the b-phase, the c-phase, and the a-phase, the N-pole moves to positions at the electrical angles from 120°, 240°, and then, 0° as shown in an order from FIGS. 6A, 6B to 6C. Thus, even when the N-pole is located in the shaded portion, the N-pole may be accurately aligned with the position at the electrical angle of 0°.

As described above, before the operation of the motor 200 is started, when the controller 30 for aligning a position of the rotor by applying the excitation power according to the application criterion may detect a position of the rotor, the controller 30 may detect a position of the rotor based on a result of the alignment of the position of the rotor, and control operation of the motor 200 based on a result of the detection.

As described above, before the operation of the motor 200 is started, the controller 30 for aligning a position of the rotor by applying the excitation power according to the application criterion may align a position of the rotor, and then, rotate the motor 200 according to a preset rotation criterion.

The preset rotation criterion may be a criterion for at least one of rotation time, a rotation speed, and a rotation number of the motor 200.

That is, the controller 30 may align the position of the rotor, and then, rotate the motor 200 according to at least one selected from the preset rotation time, preset rotation speed, and rotation number.

The rotation criterion may be a criterion for performing test rotation on the rotor of the motor so that the N-pole, located near the position at the electrical angle of 0° according to a result of the alignment, rotates according to the rotation of the motor 200 and is located in a position detected by the controller 30.

That is, the rotation criterion may be a criterion for controlling realignment of a position of the rotor of the motor 200 by rotating the rotor according to the rotation of the motor 200.

Also, the rotation criterion may be a rotation criterion for correcting a position of the N pole obtained according to the alignment result, by rotating the motor 200.

Accordingly, as the controller 30 may rotate the motor 200 according to the rotation criterion, a magnetic pole of the rotor may rotate according to the rotation of the motor 200. Thus, the position of the N-pole may be corrected to a position detected by the controller 30 through the rotation.

As a detailed example of the rotation criterion, the rotation time may be set to 1.5 [s], the rotation speed may be set to 1 [Hz], and the rotation number may be set to 1 [time].

According to this example, after the controller 30 aligns the position of the rotor, the controller 30 may rotate the motor 200 at 1 [Hz] for 1.5 [s] for 1 [time] in accordance with the rotation criterion, and thus, correct a position of the N-pole through the rotation.

The rotation criterion may also be set to a set value other than the above-mentioned example, according to a type of the motor 200 or a driving condition of the motor 200.

As such, as the controller 30 aligns the position of the rotor, and then, performs test rotation on the motor 200 according to the rotation criterion, the N-pole may be accurately aligned with the predetermined position. Accordingly, the position of the rotor may be accurately detected.

As described above, before the operation of the motor 200 is started, the controller 30 for aligning a position of the rotor by applying the excitation power according to the application criterion may align a position of the rotor, and then, control initial operation of the motor 200 according to a preset control criterion.

The preset control criterion may be a criterion for controlling the initial operation of the motor 200 so that the rotor is located in a position that may be detected by the controller 30, by controlling operation of the motor 200 by performing a predetermined control method for predetermined control time.

That is, the rotation criterion may be a criterion for a position of the rotor to be realigned by rotating the rotor of the motor 200 according the control of the operation of the motor 200.

In addition, the control criterion may be a rotation criterion for correcting a position of the N-pole, obtained according to the alignment result, to a position within a range that may be detected by the controller 30 through the operation control of the motor 200.

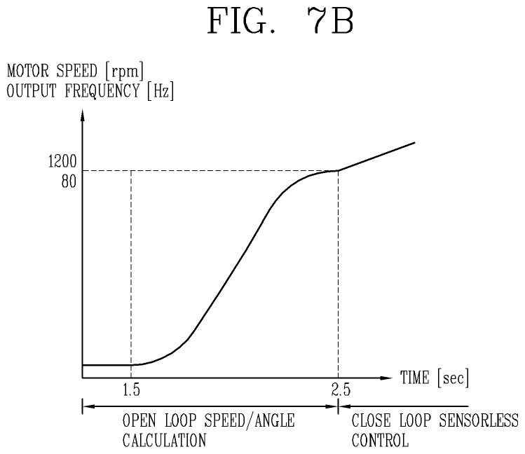

As shown in FIG. 7A, while a general initial operation of the motor 200 is performed (for 1.2 [s]), an operation speed of the motor 200 linearly increases. In this case, since a position detection speed according to rotation of the rotor may not keep up with an increasing speed of the operation speed, accurate position detection according to the rotation of the rotor may not be performed.

Accordingly, as the controller 30 may control the initial operation of the motor 200 according to the preset control criterion, the magnetic pole of the rotor may be prevented from deviating from a position that may be detected by the controller 30 according to the increase in the operation speed. Thus, the position of the N-pole may be corrected to a position that may be detected by the controller 30.

As a detailed example of the control criterion, as shown in FIG. 7B, the control time may be set to 2.5 [s] and the control method may be set to an S-curve method.

Here, the control method refers to a method of non-linearly increasing the operation speed in a form like an S-curve. In this case, the controller 30 may control the switching operation using an open loop control method.

That is, the control criterion may be a criterion for controlling the operation speed to non-linearly increase while a position of the rotor is being detected.

According to this example, the controller 30 aligns the position of the rotor, and then, controls operation of the motor 200 during a period after 1.5 [s] until 2.5 [s], that is, for 1 [s] using the S-curve method according to the preset control criterion. Thus, the position of the rotor may be detected during the initial operation.

The rotation criterion may also be set to a set value other than the above-mentioned example, according to a type of the motor 200 or a driving condition of the motor 200.

As such, as the controller 30 may align the position of the rotor, and then, control the initial operation of the motor 200 according to the preset control criterion, the controller 30 may accurately detect a position of the rotor during the initial operation in which the operation speed non-linearly increases.

As described above, before the operation of the motor 200 is started, the controller 30 for aligning the position of the rotor by applying the excitation power according to the preset application criterion may detect a position of the rotor based on a result of the alignment of the position of the rotor, and control operation of the motor 200 based on a result of the detection.

As such, before operation of the motor 200 is started, the control apparatus 100 may align the position of the rotor by applying the excitation power according to the preset application criterion and rotate the rotor according to the rotation criterion, or align the position of the rotor by rotating the rotor according to the preset rotation criterion or controlling the initial operation according to the control criterion to thereby accurately detect the position of the rotor. Thus, control of operation of the motor 200 may be stably and accurately performed.

Hereinafter, a control system for a compressor (hereinafter referred to as a control system) according to the present disclosure is described. A description provided above with respect to the control apparatus 100 is not provided here as possible.

The control system refers to a system for controlling driving of a compressor.

The control system may be a control system for controlling driving of the compressor by supplying driving power to a motor of the compressor.

The control system may be a control system for controlling the motor using an inverter method.

The control system may control operation of the motor by controlling the driving power applied to the motor through control of switching operation of the inverter.

The control system may control driving of the compressor by controlling the operation of the motor, by controlling the driving power through the control of the switching operation.

The control system may include the control apparatus 100 described above to control driving of the compressor.

The control system may be a control system that controls initial operation of the motor, that is, start of the operation of the motor.

As shown in FIG. 1, the control system includes the compressor C driven by the motor 200, and the control apparatus 100 that includes the inverter unit 20 configured to convert power, input from the external power source 1, to driving power for driving the motor 200 and output the driving power to the motor 200, and controls operation of the motor 200 by controlling switching operation of the inverter unit 20.

Here, the control apparatus 100 may be configured as the control apparatus 100 described above.

In the control system, when the motor 200 starts operation, the control apparatus 100 aligns a rotor of the motor 200 according to a preset alignment criterion, and then, controls start of the operation of the motor 200.

That is, when initial operation in which the operation of the motor 200 starts is performed, the control system aligns the rotor according to the alignment criterion, and then, controls the operation of the motor 200.

As shown in FIG. 3, the control apparatus 100 may include the inverter unit 20 and the controller 30, wherein the inverter unit 20 converts power, input from the external power source 1 to the input unit 10, to the driving power and outputs the driving power to the motor 200, and the controller 30 controls operation of the motor 200 by controlling the switching operation.

The control apparatus 100 may be a control element including different components from those of the control apparatus 100 described above.

The control apparatus 100 for controlling operation of the motor 200 by controlling the switching operation may detect a voltage and a current of the motor 200. Then, the controller 30 may measure an operation speed of the motor 200 based on the detected voltage and current of the motor 200, and control the switching operation according to the measured operation speed.

The control apparatus 100 may detect a motor voltage and a motor current applied to the motor 200 according to the switching operation, and measure the operation speed based on the motor voltage and the motor current.

The control apparatus 100 may generate a control signal for controlling the switching operation according to the operation speed, and apply the control signal to the inverter unit 20 to thereby control the switching operation.

The control apparatus 100 may determine at least one selected from a command voltage for the motor voltage, a command current for the motor current, a speed command for the operation speed, and a frequency command for the switching frequency according to the operation speed, and generate the control signal according to a result of the determination.

That is, the control apparatus 100 determines at least one selected from the command voltage, the command current, the speed command, and the frequency command based on at least one selected from a result of the detection of the motor voltage and the motor current and a result of the measurement of the operation speed. Then, the controller 30 may generate the control signal according to a result of the determination to thereby control the switching operation. Thus, the controller 30 may control at least one selected from the motor voltage, the motor current, the operation speed, and the switching frequency.

As described above, the control apparatus 100 may control at least one selected from the motor voltage, the motor current, the operation speed, and the switching frequency through the control of the switching operation to thereby control the operation of the motor 200.

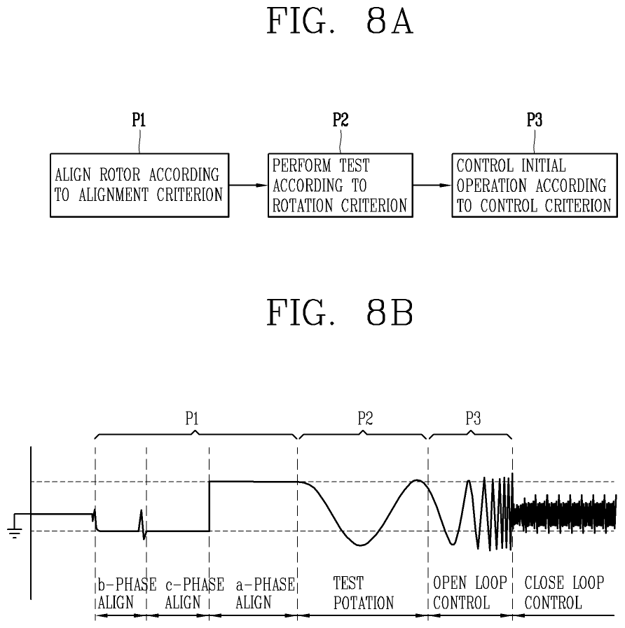

As such, a process of controlling the start of operation, by the control apparatus 100 that controls conversion and output of the driving power by controlling the switching operation of the inverter unit 20, may be performed in an order shown in FIGS. 8A and 8B.

In the control system, the control apparatus 100 may control operation of the motor 200 in the controlling process shown in FIGS. 8A and 8B.

Here, the controlling process shown in FIGS. 8A and 8B may be performed by the controller 30 in the control apparatus 100, and be applied to the embodiment described above with respect to the controller 30 included in the control apparatus 100.

As shown in FIGS. 8A and 8B, when the motor 200 starts to operate, the rotor is aligned according to the preset alignment criterion (P1), and then, controls the start of the operation of the motor 200.

The alignment criterion may be a criterion for aligning an N-pole of the rotor with a predetermined position with reference to a slot of the stator of the motor 200.

That is, the control apparatus 100 may align the N-pole with the predetermined position.

The control apparatus 100 may sequentially apply the excitation power to a plurality of slots among respective slots of the stator according to the preset alignment criterion to thereby align the rotor with the predetermined position.

That is, the control apparatus 100 may align the rotor with the predetermined position by aligning the rotor according to an order for applying the excitation power.

The alignment criterion may be a criterion for aligning the N-pole with positions of slots to which b-phase, c-phase, and a-phase power are applied, among the slots of the stator.

The alignment criterion may be a criterion for aligning the rotor with positions of the slots in an order of the slots corresponding to a b-phase, a c-phase, and an a-phase, among the slots of the stator.

The control apparatus 100 may align the N-pole of the rotor with reference to the a-phase of the stator in an order from electrical angles of 120°, 240°, to 0°.

That is, the predetermined position may be a position corresponding to the a-phase of the stator.

As an example, such an alignment may be performed in an order shown from FIGS. 6A, 6B to 6C.

As described above, the control apparatus 100 for aligning aligns the rotor according to the preset alignment criterion (P1), and then, controlling the start of operation of the motor 200 may perform test rotation on the motor 200 (P2) according to a preset rotation criterion after aligning the rotor.

The preset rotation criterion may be a criterion for at least one of rotation time, a rotation speed, and a rotation number of the motor 200.

That is, after the control apparatus 100 aligns the rotor according to the alignment criterion (P1), the control apparatus 100 may rotate the motor 200 according to at least one selected from the rotation time, the rotation speed, and the rotation number of the motor 200 that are preset (P2).

The rotation criterion may be a criterion for performing test rotation so that the N-pole, located in a position near an electrical angle of 0° according to a result of the alignment, rotates according to the rotation of the motor 200 and to be thereby located in a position detected by the controller 30.

That is, the rotation criterion may be a criterion for controlling a position of the rotor to be realigned by rotating the rotor according to the rotation of the motor 200.

Also, the rotation criterion may be a rotation criterion for correcting a position of the N pole, obtained according to the alignment result, by rotating the motor 200.

Accordingly, as the control apparatus 100 may rotate the motor 200 (P2) according to the rotation criterion, a magnetic pole of the rotor also rotates according to the rotation of the motor 200. Thus, a position of the N-pole may be corrected to a position detected by the controller 30 through the rotation.

As such, after the control apparatus 100 aligns the position of the rotor (P1) according to the alignment criterion, the control apparatus 100 performs test rotation on the motor 200 (P2) according to the preset rotation criterion. Thus, the control apparatus 100 may accurately align the N-pole with the predetermined position and, accordingly, the position of the rotor may be accurately detected.

As described above, after the control apparatus 100 for aligning the rotor (P1) according to the preset alignment criterion and performing test rotation on the motor 200 (P2) according to the preset rotation criterion rotates the motor 200 (P2) according to the rotation criterion, the control apparatus 100 may control initial operation of the motor 200 (P3) according to a preset control criterion.

The control criterion may be a criterion for controlling operation of the motor 200 during a predetermined control time period by performing a predetermined control method to thereby control the initial operation so that the rotor is located in a position that may be detected by the controller 30.

That is, the control criterion may be a criterion for controlling a position of the rotor to be realigned by rotating the rotor according to control of the operation of the motor 200.

The control criterion may be a rotation criterion for correcting a position of the N-pole, obtained according to the alignment result, to a position within a range that may be detected by the control apparatus 100 through the control of the operation of the motor 200.

Accordingly, as the control apparatus 100 controls the initial operation of the motor 200 (P3) according to the control criterion, the control apparatus 100 may prevent a magnetic pole of the rotor from deviating from a position that may be detected by the control apparatus 100. Thus, a position of the N-pole may be corrected to a position that may be detected by the control apparatus 100.

As such, as the control apparatus 100 aligns the position of the rotor (P1 and P2) and controls the initial operation according to the preset control criterion (P3), a position of the rotor may be accurately detected during the initial operation in which the operation speed non-linearly increases.

As described above, before the operation of the motor 200 starts, the control apparatus 100, which aligns the position of the rotor according to the alignment criterion, may detect a position of the rotor based on a result of the alignment of the position of the rotor, and control the start of the operation of the motor 200 based on the detected position.

As such, before the operation of the motor 200 is started, the control apparatus 100 aligns a position of the rotor by applying the excitation power according to the alignment criterion, rotates the rotor according to the rotation criterion, and aligns a position of the rotor by controlling the initial operation according to the control criterion. Thus, the position of the rotor may be detected accurately and, accordingly, the control of the operation of the motor 200 may be stably and accurately performed.

As described above, the control system for controlling the start of operation by aligning a position of the rotor may also control start of the operation in a process other than the controlling process shown in FIGS. 8A and 8B.

Hereinafter, a method for controlling a compressor according to the present disclosure (hereinafter referred to as a control method) is described. Descriptions provided above with respect to the control apparatus 100 and the control system are not to be provided here again as possible.

The control method may be a control method for controlling the compressor.

The control method may be a control method for controlling the control apparatus that controls the compressor.

The control method may be a control method performed by the control apparatus 100 or the control system described above.

The control method may be a method for detecting a position of the motor, or a method for controlling start of operation of the motor by detecting the position of the motor.

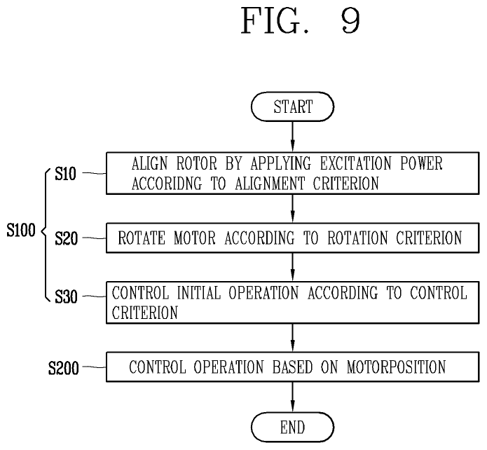

As shown in FIG. 3, the control method is a method for, by the control apparatus 100, controlling a compressor, the control apparatus 100 including the inverter unit 20 and the controller 30, wherein the inverter unit 20 converts power, input from the external power source 1 to the input unit 10, to driving power for driving the motor 200 of the compressor C and outputs the driving power to the motor 200, and the controller 30 controls switching operation of the inverter unit 20 to thereby control operation of the motor 200. As shown in FIG. 9, the control method includes aligning a rotor of the motor 200 by applying excitation power to the stator of the motor 200 according to a preset application criterion (S10), rotating the motor 200 according to a preset rotation criterion (S20), and controlling initial operation of the motor 200 according to a preset control criterion (S30).

That is, the control apparatus 100 or the controller 30 included in the control apparatus 100 may align the rotor of the motor 200 by applying the excitation power to the stator according to the preset application criterion (S10), rotate the motor 200 according to the rotation criterion (S20), and control initial operation of the motor 200 according to the preset control criterion (S30) to thereby control driving of the compressor C.

The alignment (S10), the rotating (S20) and the controlling of the initial operation (S30) may be included in controlling of start of operation of the motor 200 (S100).

In the aligning (S10), the excitation power may be applied to slots in an order of slots corresponding to a b-phase, a c-phase, and an a-phase of the stator according to the preset application criterion to thereby align an N-pole of the rotor.

That is, the application criterion may be a criterion for an order of applying the excitation power to respective slots of the stator.

The application criterion may be a criterion for an order of applying the excitation power to a plurality of slots among the respective slots.

That is, in the aligning (S10), the excitation power may be sequentially applied to a plurality of slots among the respective slots according to the preset application criterion to thereby sequentially excite the plurality of slots.

In the aligning (S10), the excitation power may be applied according to the preset application criterion to thereby align the N-pole of the rotor with a predetermined position.

The predetermined position may be a position corresponding to an a-phase of the stator.

That is, the preset application criterion may be a criterion for an order of applying the excitation power such that the N-pole is aligned with a position corresponding to the a-phase of the stator.

In addition, the application criterion may be a criterion for applying the excitation power in an order of slots corresponding to the b-phase, the c-phase, and the a-phase of the stator.

That is, in the aligning (S10), the application power may be applied to the slots corresponding to the b-phase, the c-phase, and the a-phase in an order of the b-phase, the c-phase, and the a-phase to thereby excite the slots in an order of the slots corresponding to the b-phase, the c-phase, and the a-phase.

In the rotating (S20), the motor 200 may be rotated during a predetermined rotation time period at a predetermined rotation speed for a predetermined rotation number according to the rotation criterion.

That is, the rotation criterion may be a criterion for at least one of rotation time, a rotation speed, and the rotation number of the motor 200.

That is, in the rotating (S20), the position of the rotor may be aligned, and then, the motor 200 may be rotated according to rotation time, the rotation speed, and the rotation number of the motor 200 that are preset.

The rotation criterion may be a criterion for performing test rotation so that the N-pole, located in a position near the electrical angle of 0° according to a result of the alignment, rotates according to rotation of the motor 200, and thus, is located in a position detected by the control apparatus 100.

That is, the rotation criterion may be a criterion for controlling a position of the rotor to be realigned by rotating the rotor according to the rotation of the motor 200.

Also, the rotation criterion may be a rotation criterion for correcting a position of the N pole obtained according to the alignment result, by rotating the motor 200.

That is, in the rotating (S20), the motor 200 is rotated according to the rotation criterion, and thus, a magnetic pole of the rotor also rotates according to the rotation of the motor 200 so that a position of the N-pole may be corrected to a position detected by the controller 30 through the rotation.

In the controlling (S30), the motor 200 may be controlled during a predetermined rotation time period by performing a predetermined control method according to the control criterion.

That is, the control criterion may be a criterion for controlling initial operation so that the rotor is located in a position that may be detected by the controller 30, by controlling operation of the motor 200 during a predetermined control time period using a predetermined control method.

The control criterion may be a criterion for controlling a position of the rotor to be realigned by rotating the rotor according the control of the operation of the motor 200.

The control criterion may be a rotation criterion for correcting a position of the N-pole, obtained according to the alignment result, to a position within a range that may be detected by the controller 30 through the operation control of the motor 200.

That is, in the controlling (S30), the initial operation of the motor 200 may be controlled according to the preset control criterion to thereby prevent the magnetic pole of the rotor from deviating from a position that may be detected by the controller 30 according to an increase in the operation speed. Thus, a position of the N-pole may be corrected to a position that may be detected by the controller 30.

Here, the control method refers to a method of non-linearly increasing the operation speed in a form like an S-curve. In this case, the controller 30 may control the switching operation by using an open loop control method.

That is, the control criterion may be a criterion for controlling the operation speed to non-linearly increase while a position of the rotor is being detected.

As such, as the position of the rotor is aligned, and then, the initial operation of the motor 200 is controlled according to the rotation criterion, a position of the rotor may be accurately detected during the initial operation in which the operation speed non-linearly increases.

In the control method described above, before operation of the motor 200 starts, a position of the rotor is aligned by applying the excitation power according to the alignment criterion (S10), the rotor is rotated according to the rotation criterion (S20), and the position of the rotor is aligned by controlling the initial operation according to the preset control criterion (S30) to thereby control the initial operation (S100). In the control method, the position of the rotor may be detected based on a result of the alignment of the rotor, and operation of the motor 200 may be controlled based on the detected position of the rotor (S200).

As such, in the control method, the controlling of the initial operation (S100) may include the alignment of the position of the rotor by applying the excitation power according to the application criterion (S10), the rotation of the rotor according to the rotation criterion (S20), the alignment of the position of the rotor by controlling the initial operation according to the control criterion (S30). Thus, the position of the rotor may be accurately detected, and thus, the control of the operation of the motor 200 may be stably and accurately performed.

So far, the detailed embodiments according to the present disclosure have been described, but it will be understood by those skilled in the art that various changes and modifications may be made therein without departing from the spirit and scope of the disclosure. Therefore, the scope of the present disclosure should not be limited by the described embodiments, but should be determined by the scope of the appended claims and equivalents thereof.

The present disclosure has been particularly shown and described with reference to those exemplary embodiments, it is to be understood that various changes and modification can be made from this disclosure by those skilled in the art to which the present disclosure belongs. Accordingly, the scope of the present disclosure should be defined by the following claims, and various changes equal or equivalent to the claims pertain to the category of the concept of the present disclosure.

What is claimed is:

1. An apparatus for controlling a compressor that includes a motor including a stator and a rotor configured to rotate relative to the stator, the apparatus comprising:
an inverter unit that is configured to convert an input power supplied from an external power source through an input unit to a driving power for driving the motor, the inverter unit being configured to output the driving power to the motor; and
a controller that is configured to control an operation of the motor by controlling a switching operation of the inverter unit,
wherein the controller is configured to, before starting of the operation of the motor, align a position of the rotor to a position of the stator by applying an excitation power to the stator according to a preset application criterion.

2. The apparatus of claim 1, wherein the stator comprises a plurality of slots corresponding to a plurality of positions of the rotor, and
wherein the preset application criterion comprises a preset sequence for applying the excitation power to one or more of the plurality of slots of the stator.

3. The apparatus of claim 2, wherein the controller is configured to apply the excitation power, according to the preset sequence, to (i) one or more slots of the stator corresponding to a b-phase, (ii) one or more slots of the stator corresponding to a c-phase, and (iii) one or more slots of the stator corresponding to an a-phase.

4. The apparatus of claim 1, wherein the controller is configured to align an N-pole of the rotor to a predetermined position by applying the excitation power according to the preset application criterion.

5. The apparatus of claim 4, wherein the predetermined position is a position of the stator corresponding to an a-phase.

6. The apparatus of claim 1, wherein the controller is configured to rotate the motor according to a preset rotation criterion based on alignment of the position of the rotor.

7. The apparatus of claim 6, wherein the preset rotation criterion comprises at least one of a rotation duration, a rotation speed, or a rotation number of the motor.

8. The apparatus of claim 1, wherein the controller is configured to control an initial operation of the motor according to a preset control criterion based on alignment of the position of the rotor.

9. The apparatus of claim 8, wherein the preset control criterion comprises a predetermined control method and a predetermined control time period, and
wherein the controller is configured to control the operation of the motor according to the predetermined control method during the predetermined control time period.

10. The apparatus of claim 1, wherein the controller is configured to:
detect a rotor position based on a result of alignment of the position of the rotor to the position of the stator; and
control the operation of the motor based on the rotor position.

11. A control system for a compressor, the control system comprising:
a motor configured to drive a compressor, the motor comprising a stator and a rotor configured to rotate relative to the stator; and
a control apparatus comprising an inverter unit that is configured to convert an input power supplied from an external power source to a driving power for driving the motor, that is configured to output the driving power to the motor, and that is configured to control an operation of the motor by controlling a switching operation of the inverter unit,
wherein the control apparatus is configured to control starting of the operation of the motor based on aligning a position of the rotor to a position of the stator according to a preset alignment criterion.

12. The control system of claim 11, wherein the preset alignment criterion comprises a predetermined position of an N-pole of the rotor, the predetermined position corresponding to a slot of the stator.

13. The control system of claim 12, wherein the control apparatus is configured to sequentially align the N-pole of the rotor to positions of the stator corresponding to electrical angles of 120 degrees, 240 degrees, and 0 degrees, respectively, with respect to an a-phase of the stator.

14. The control apparatus of claim 11, wherein the control apparatus is configured to perform a test rotation of the motor according to a preset rotation criterion based on alignment of the position of the rotor.

15. The control apparatus of claim 14, wherein the control apparatus is configured to control an initial operation of the motor according to a preset control criterion based on the motor being rotated according to the preset rotation criterion.

16. The control apparatus of claim 11, wherein the control apparatus is configured to:
detect a rotor position based on a result of alignment of the position of the rotor to the position of the stator; and
control the operation of the motor based on the rotor position.

17. A method of an apparatus configured to control a compressor, the apparatus including an inverter unit that is configured to convert an input power supplied from an external power source through an input unit to a driving power for driving a motor of the compressor and that is configured to output the driving power to the motor, and a controller configured to control an operation of the motor by controlling a switching operation of the inverter unit, the method comprising:
aligning a position of a rotor of the motor to a position of a stator of the motor by applying an excitation power to the stator according to a preset application criterion;
rotating the motor according to a preset rotation criterion; and
controlling an initial operation of the motor according to a preset control criterion.

18. The method of claim 17, wherein aligning the position of the rotor comprises:
applying the excitation power, according to a preset sequence, to (i) one or more slots of the stator corresponding to a b-phase, (ii) one or more slots of the stator corresponding to a c-phase, and (iii) one or more slots of the stator corresponding to an a-phase.

19. The method of claim 17, wherein rotating the motor comprises:
rotating the motor at a predetermined rotation speed during a predetermined rotation time period for a predetermined rotation number.

20. The method of claim 17, wherein controlling the initial operation of the motor comprises:
controlling the motor based on a predetermined control method during a predetermined control time period.
